(19) United States
(12) Patent Application Publication
(10) Pub. No.: US 2002/0196360 A1
(43) Pub. Date: Dec. 26, 2002

(54) Cradle for digital camera

(75) Inventor: Shunichi Miyadera, Tokyo (JP)

Correspondence Address: GREENBLUM & BERNSTEIN, P.L.C., 1941 ROLAND CLARKE PLACE, RESTON, VA, 20191, US

(73) Assignee: ASAHI KOGAKU KOGYO KABUSHIKI KAISHA, Tokyo (JP)

(21) Appl. No.: 10/157,187

(22) Filed: May 30, 2002

(30) Foreign Application Priority Data
May 31, 2001 (JP) P2001-163843

(51) Int. Cl. H04N 5/225

(52) U.S. Cl. 348/373

(57) ABSTRACT

A cradle for a digital camera comprises a connector to which a plurality different kinds of digital cameras can be selectively and detachably connected. The camera body of the digital camera is provided with a magnet located at a position which is changed in accordance with the kind of the digital camera, or provided with a magnet having a magnetic force the value of which corresponds to the kind of digital camera. The cradle has a magnetic sensor and a sensing circuit. The sensing circuit determines the kind of digital camera connected to the connector, by sensing the magnet. The magnet and the magnetic sensor may be replaced with a reflecting member and an optical sensor.

### BACKGROUND OF THE INVENTION

1. Field of the Invention

The present invention relates to a cradle to which a digital camera is attached, so that the digital camera is connected to a computer through a predetermined communication cable.

2. Description of the Related Art

Conventionally, there is known a system, in which a digital camera is connected to a computer not directly through a communication cable, but is attached to a cradle, to which a communication cable is connected, so that the digital camera is connected to the computer. That is, in the case of a digital camera connected to a computer through a USB cable, a cradle should be used, to which the USB cable is connected, and in the case of a digital camera connected to the computer through an IEEE1394 cable, a cradle should be used, to which the IEEE1394 cable is connected.

Thus, it is necessary to provide a cradle in accordance with the kind of the digital camera being used. That is, for connecting a plurality of different kinds of digital camera to a single computer, a plurality of cradles should be prepared in accordance with the kinds of the communication cables, which is cumbersome.

### SUMMARY OF THE INVENTION

Therefore, an object of the present invention is to provide a cradle to which a plurality different kinds of digital cameras can be connected.

According to the present invention, there is provided a cradle for a digital camera, comprising a connector and a camera determining processor. A plurality different kinds of digital cameras can be selectively and detachably connected to the cradle. The camera determining processor has either a magnetic sensor or an optical sensor for sensing the kind of digital camera connected to the connector.

Further, according to the present invention, there is provided a digital camera system comprising a digital camera and a cradle that has a connector and a camera determining processor. The digital camera is provided with a magnet, the location of which or the value of the magnetic force of which corresponds to the kind of the digital camera, or a reflecting member, the location of which or the value of the reflectance of which corresponds to the kind of the digital camera. A plurality different kinds of digital cameras can be selectively and detachably connected to the cradle. The camera determining processor determines the kind of digital camera connected to the connector by sensing the magnetic force or the reflected light generated by light radiated onto the reflecting member.

### BRIEF DESCRIPTION OF THE DRAWINGS

The objects and advantages of the present invention will be better understood from the following description, with reference to the accompanying drawings in which:

FIG. 1 is a perspective view showing a cradle and a digital camera, to which a first embodiment of the present invention is applied;

FIG. 2 is a perspective view showing a connector of a cradle and a connector of the digital camera;

FIG. 3 is a block diagram showing an electric structure of the cradle;

FIG. 4 is a flowchart of a switch control routine;

FIG. 5 is a flowchart of a connecting condition reset routine;

FIG. 6 is a flowchart of a set process routine for a first kind of digital camera;

FIG. 7 is a flowchart of a set process routine of a second kind of digital camera;

FIG. 8 is a block diagram showing an electric structure of a cradle of a second embodiment;

FIG. 9 is a block diagram showing an electric structure of a cradle of a third embodiment; and

FIG. 10 is a block diagram showing an electric structure of a cradle of a fourth embodiment.

### DESCRIPTION OF THE PREFERRED EMBODIMENTS

The present invention will be described below with reference to the embodiments shown in the drawings.

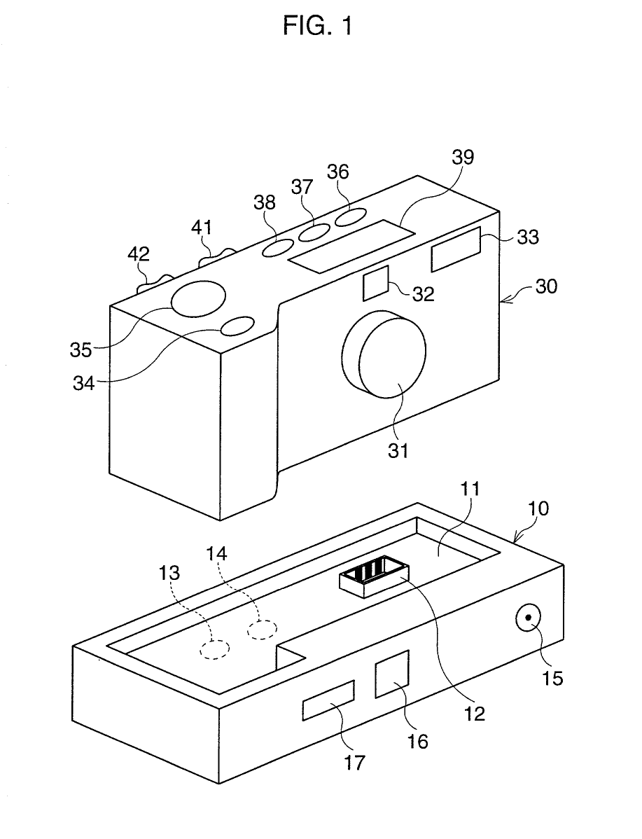

FIG. 1 is a perspective view showing a cradle and a digital camera, to which a first embodiment of the present invention is applied.

A recess portion 11 is formed on the cradle 10, and the shape of the recess portion 11 conforms to the bottom of the camera body 30 of the digital camera. A connector 12 is provided on the recess portion 11. The bottom of the camera body 30 has a connector (not shown), which is connected to the connector 12. First and second magnetic sensors 13 and 14 are embedded in the recess portion 11, in order to sense a magnet (not shown) provided in the camera body 30. Namely, a plurality of kinds of digital cameras can be selectively and detachably connected to the connector 12, and the kind of the connected digital camera is detected based on the sensing result of the magnetic sensors 13 and 14, which will be described later.

An AC connector 15, to which an AC adaptor (not shown) is connected, is provided on a side surface of the cradle 10. Further, a first communication connector 16 and a second communication connector 17, to which a USB cable and an IEEE1394 cable can be connected, are provided on the side surface of the cradle 10. A photographing lens 31, a viewfinder 32, and an electronic flash 33 are mounted on a front surface of the camera body 30. A release switch 34, a mode dial 35, an electronic flash switch 36, a remote controller timer switch 37, a macro switch 38, and a liquid crystal display panel 39 are disposed on an upper surface of the camera body 30. By operating the release switch 34, a photographing operation is performed. When the mode dial 38 is handled, an operation mode, such as a photographing mode, is changed or set. The electronic flash switch 36 is used for irradiating the electronic flash 33. The remote-control timer switch 37 is provided for setting the waiting time for a remote-control shot. The macro switch 38 is operated for macro photography. On the liquid crystal display panel 39, various kinds of information such as the photographing mode of the digital camera is indicated.

A power switch 41 and a zoom switch 42 are provided on a rear surface of the camera body 30. By handling the power switch 41, electric power is supplied to electric circuits mounted in the camera body 30. By handling the zoom switch 42, a zooming operation of the photographing lens 31 is carried out.

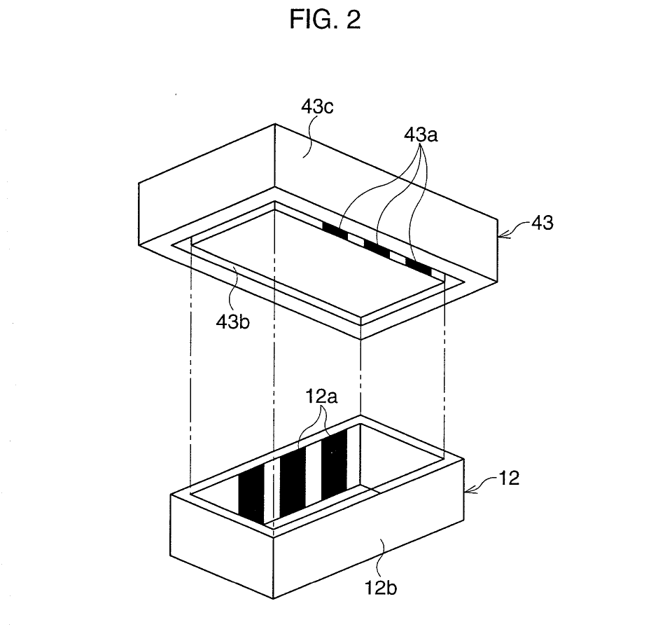

FIG. 2 shows the connector 12 of the cradle and the connector 43 of the digital camera. Note that, in this drawing, although the connector 12 is viewed obliquely from the upper side in a similar way as FIG. 1, the connector 43 is viewed obliquely from the lower side.

The connector 12 has a rectangular frame shape, when viewed from the upper side. Two of the four inner walls of the connector 12, which face each other, are provided with electrodes 12a, and the other two inner walls, which face each other, are not provided with electrodes. A metal sheet 12b, which serves as a shield, is applied to the whole of the outer wall. The connector 43 has a rectangular parallelepiped body, which is fit in the connector 12, and the outer surface of the body is provided with an electrode 43a, which comes in contact with the electrode 12a of the connector 12. The body of the connector 43 is enclosed by a frame 43c, and a metal sheet 43b, coming into contact with the metal sheet 12a of the connector 12, is applied to the whole of the inner wall of the frame 43c.

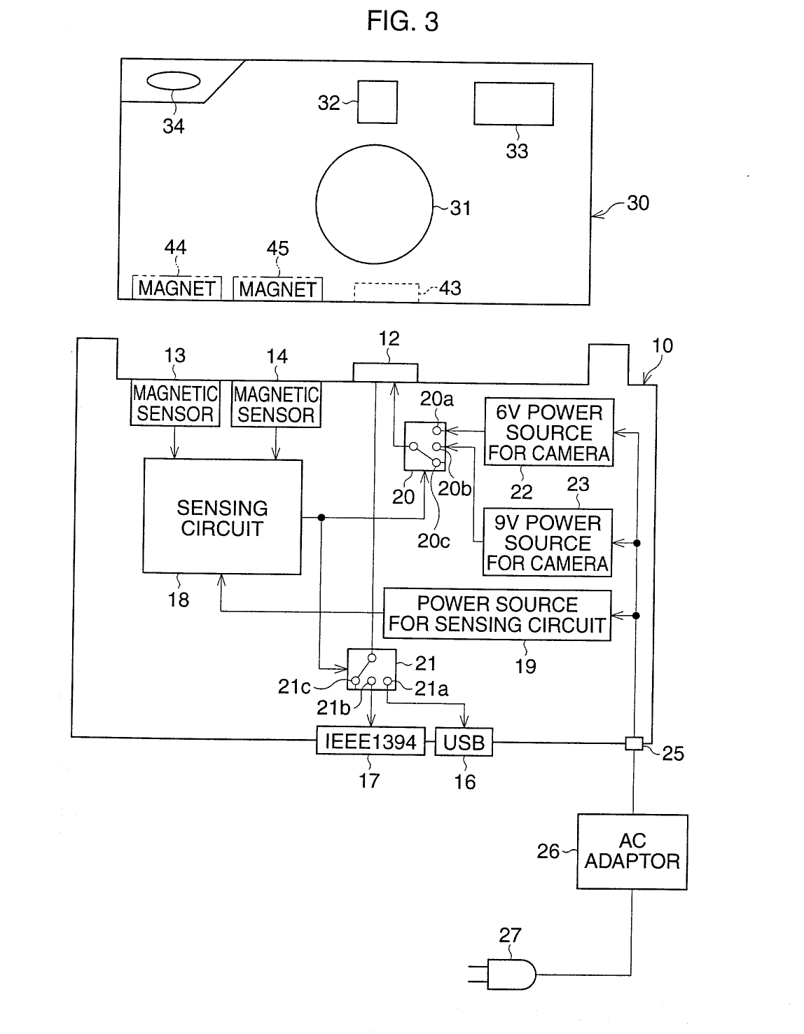

FIG. 3 shows an electric structure of the cradle 10.

The connector 43 is mounted close to the bottom on the camera body 30, in which a first or second magnet 44 or 45 is provided at a position corresponding to the first or second magnetic sensor 13 or 14. Namely, a first kind of digital camera is provided with only the first magnet 44, and a second kind of digital camera is provided with only the second magnet 45, so that the kind of the digital camera is determined by detecting the first or second magnet 44 or 45.

In the cradle 10, the first and second magnetic sensors 13 and 14 are connected to a sensing circuit 18. The magnetic sensors 13 and 14 generate sensing signals when a magnet is close thereto, and in the close state, the sensing circuit 18 generates a switch signal, corresponding to the kind of the digital camera, based on the sensing signal. The sensing circuit 18 is operated using electric power supplied from a power source for sensing circuit 19, and the generated switch signal is output to a power source switch 20 and an interface switch 21.

The power source switch 20 has a first contact 20a connected to a 6V power source circuit for camera 22, a second contact 20b connected to a 9V power source circuit for camera 23, and a neutral point 20c not connected to the power source circuit 22 nor 23, and is constructed in such a manner that one of the contacts 20a, 20b, or the neutral point 20c is selectively electrically connected to the connector 12. The power source circuits 19, 22, and 23 are connected to a power source connector 25, to which an AC adapter 26 for converting alternating voltage of 100V to a direct voltage of a predetermined value, is connected. An alternating voltage is applied to the AC adaptor through a plug 27, so that the 6V power source circuit 22 and the 9V power source circuit 23 supply electric power to the digital camera.

The interface switch 21 has a first contact 21a connected to the first communication connector 16, a second contact 21b connected to the second communication connector 17, and a neutral point 21c not connected to the communication connector 16 nor 17, and is constructed in such a manner that one of the contacts 21a, 21b, or the neutral point 21c is selectively electrically connected to the connector 12. As described above, a USB cable can be connected to the first communication connector 16, and an IEEE1394 cable can be connected to the second communication connector 17.

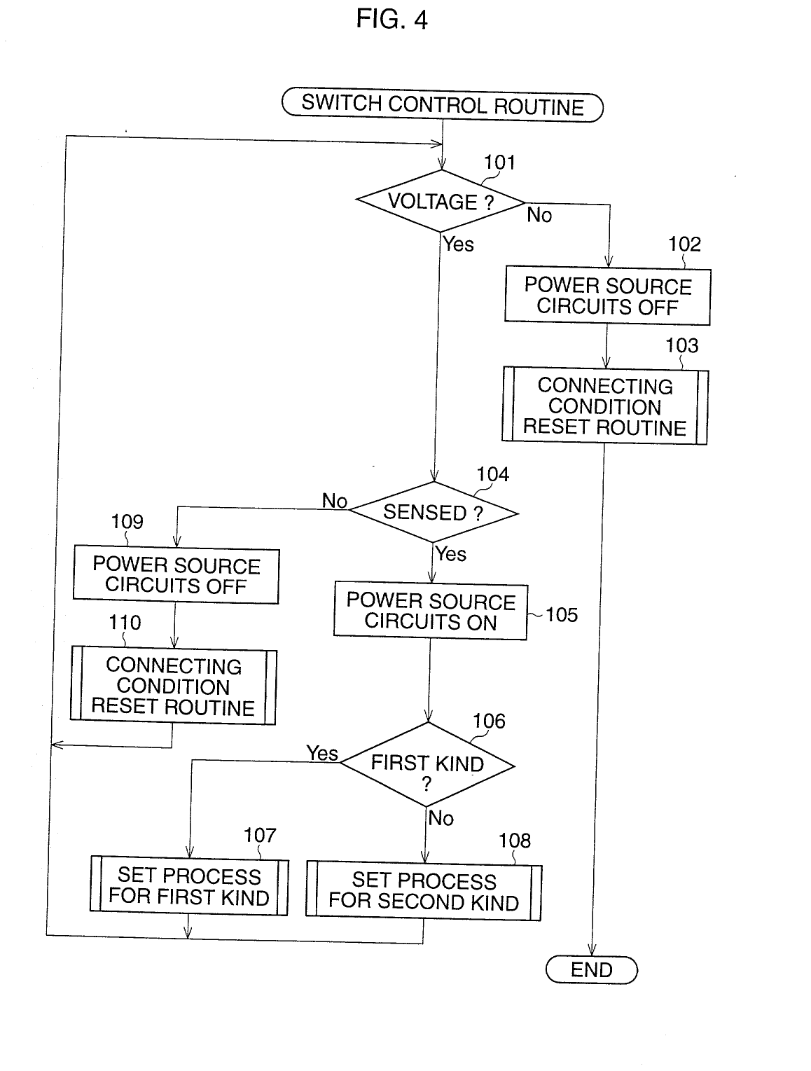

With reference to FIGS. 4 through 7, an operation of the embodiment will be described below.

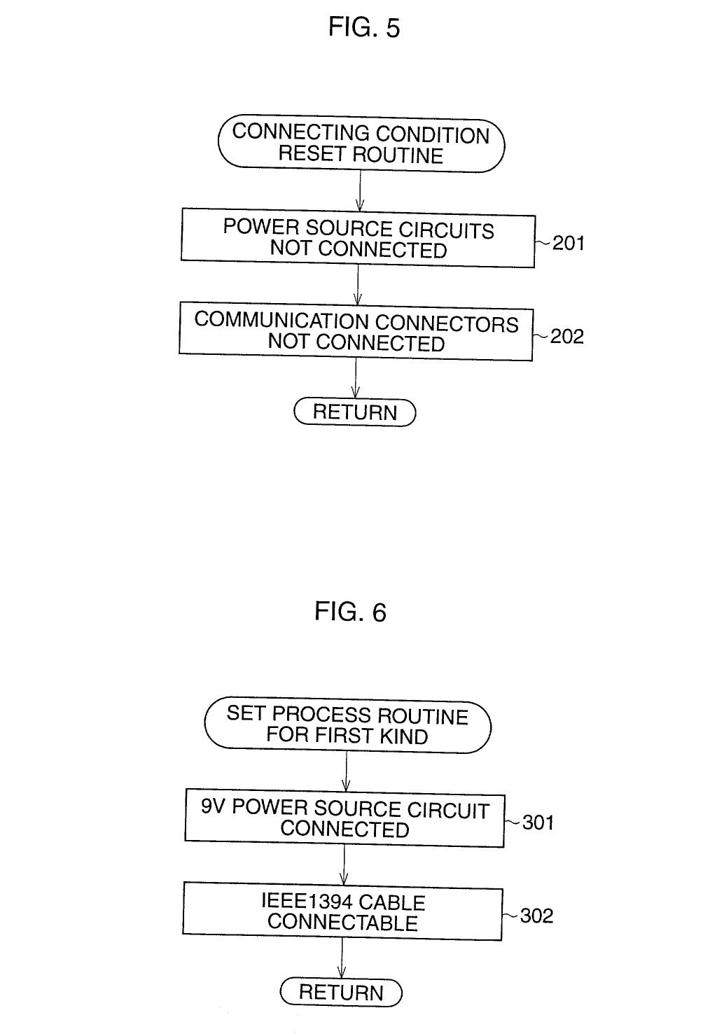

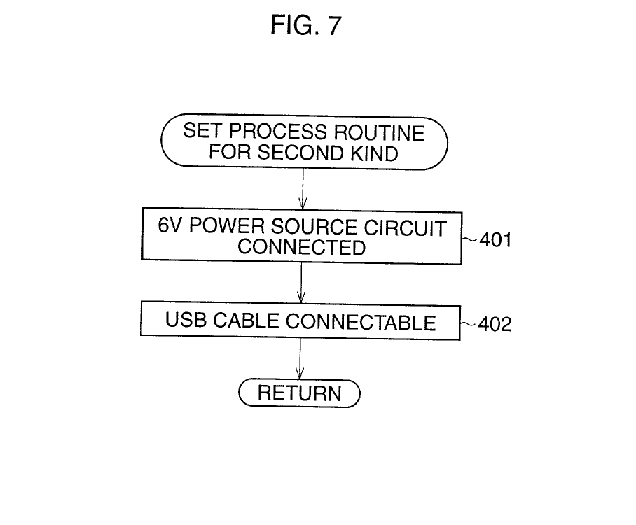

FIG. 4 is a flowchart of a switch control routine. This routine determines the kind of a digital camera attached to the cradle 10, so that the power source switch 20 and the interface switch 21 are controlled. FIG. 5 is a flowchart of a connecting condition reset routine. FIG. 6 is a flowchart of a set process routine for the first kind of digital camera. FIG. 7 is a flowchart of a set process routine for the second kind of digital camera.

In Step 101, it is determined whether direct voltage having a predetermined value is applied to the power source connector 25. When the direct voltage is not applied to the power source connector 25, Steps 102 and 103 are performed, and this routine ends. In Step 102, the 6V power source circuit 22 and the 9V power source circuit 23 are turned OFF, so that these circuits 22 and 23 do not generate voltages. In Step 103, the connecting condition reset routine, which is a subroutine of the switch control routine, is executed.

In the connecting condition reset routine, first, Step 201 is executed, in which the power source switch 20 is switched in such a manner that the neutral point 20c is connected to the connector 12. Namely, the power source circuits 22 and 23 are not connected to the connector 12. In Step 202, the interface switch 21 is switched in such a manner that the neutral point 21c is connected to the connector 12. Namely, the communication connectors 16 and 17 are not connected to the connector 12.

When it is determined in Step 101 that the direct voltage is applied to the power source connector 25, Step 104 is executed, in which it is determined whether the first or second magnet 44 or 45 is sensed by the sensing circuit 18, i.e., whether a predetermined sensing signal is output from the sensing circuit 18. When the sensing signal is not output from the sensing circuit 18, i.e., when no camera is connected to the connector 12, Step 109 and 110 are executed, and the process then goes back to Step 101. Conversely, when the sensing signal is output, the process goes to Step 105.

In Step 109, the 6V power source circuit 22 and the 9V power source circuit 23 are turned OFF, and in Step 110, the connecting condition reset routine is executed. In the connecting condition reset routine, in Step 201, the power source switch 20 is switched to connect the neutral point 20c to the connector 12. When it is determined in Step 104 that the sensing signal is not output, usually, a camera is being changed, and the execution of Step 201 prevents an improper power source circuit from being connected to the connector 12 while the camera is being changed. In Step 202, the interface switch 21 is switched to connect the neutral point 21c to the connector 12.

Thus, when a digital camera is not connected to the connector 12, an electric power is prevented from being supplied to the digital camera by the power source circuits 22 and 23.

In Step 105, the 6V power source circuit 22 and the 9V power source circuit 23 are turned ON by the sensing circuit 18. Thus, the 6V power source circuit 22 generates a voltage of 6V, and the 9V power source circuit 23 generates a voltage of 9V. In Step 106, the kind of digital camera is judged based on the sensing signal output from the sensing circuit 18. When it is determined that the digital camera is the first kind, Step 107 is executed, and when it is determined that the digital camera is not the first kind, Step 108 is executed. After the execution of Step 107 or 108, the process goes back to Step 101.

In Step 107, the set process routine for the first kind of digital camera (FIG. 6) is executed. In Step 301 of the set process routine, the power source switch 20 is switched in such a manner that the second contact 20b, connected to the 9V power source circuit 23, is connected to the connector 12. Therefore, a voltage of 9V is applied to the digital camera. In Step 302, the interface switch 21 is switched in such a manner that the second contact 21b connected to the second communication connector 17 is connected to the connector 12. Therefore, the digital camera becomes connectable to the IEEE1394 cable.

On the other hand, in Step 108, the set process routine for the second kind of digital camera (FIG. 7) is executed. In Step 401 of the set process routine, the power source switch 20 is switched in such a manner that the first contact 20a, connected to the 6V power source circuit 23, is connected to the connector 12. Therefore, a voltage of 6V is applied to the digital camera. In Step 402, the interface switch 21 is switched in such a manner that the first contact 21a, connected to the first communication connector 17, is connected to the connector 12. Therefore, the digital camera becomes connectable to the USB cable.

As described above, in the first embodiment, the digital camera is provided with the first or second magnet 44 or 45, located at a position which is changed in accordance with the kind of digital camera, so that the kind of digital camera is determined by sensing the magnet 44 or 45, with the sensing circuit 18. Then, in accordance with the determined result (i.e., the kind of digital camera), electric power of 6V or 9V is supplied to the digital camera, and the first or second communication connector 16 or 17 is electrically connected to the digital camera.

Accordingly, a plurality different kinds of digital cameras can be selectively attached to the single cradle 10, and in accordance with the kind of digital camera, a predetermined voltage is automatically applied to the digital camera, and a communication cable corresponding to the interface can be electrically connected to the digital camera. Thus, the handling of the cradle 10 is simple. Further, the cradle 10 is constructed in such a manner that the kind of digital camera is magnetically sensed by the magnetic sensors 13 and 14, which are not projected from the bottom surface of the recess portion 11. Namely, on the surfaces of the cradle 10, the number of projecting members is restricted to as few as possible, which makes handling the cradle 10 easy.

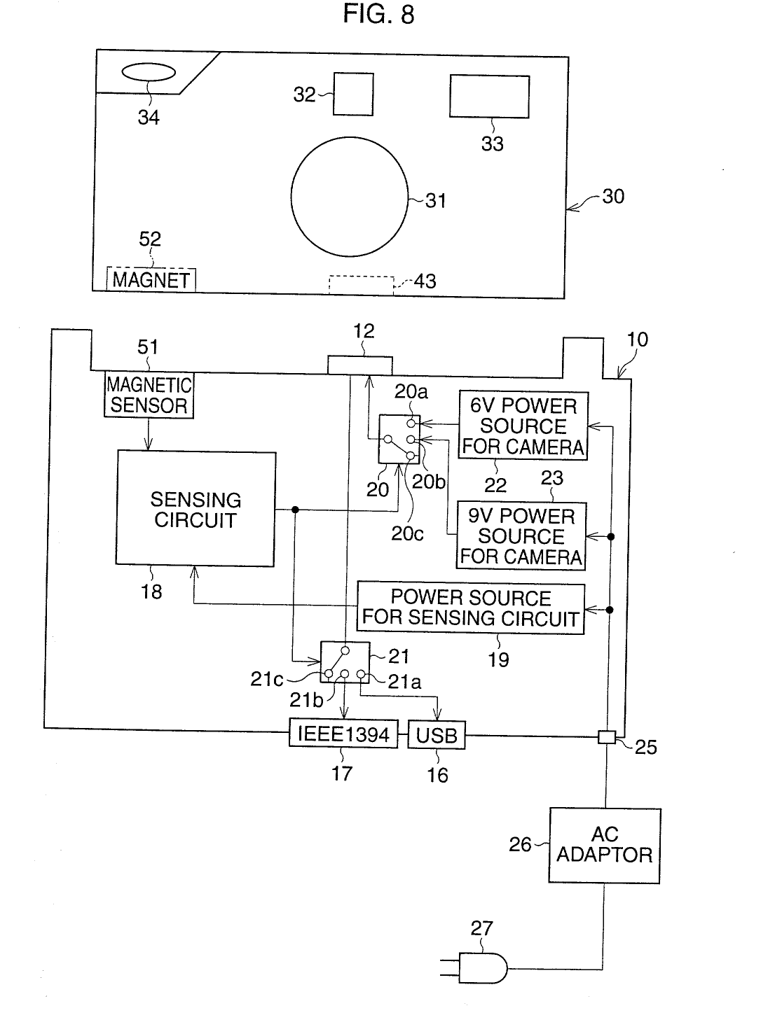

FIG. 8 shows the electric structure of the cradle 10 of a second embodiment. The cradle 10 is provided with a single magnetic sensor 51, and the camera body 30 is provided with a single magnet 52, located at a position corresponding to the magnetic sensor 51. The magnetic force of the magnet 52 corresponds to the kind of digital camera. Namely, the magnetic sensor 51 senses the kind of digital camera, based on the magnetic force of the magnet 44. The other constructions and operation are basically the same as those of the first embodiment.

Thus, according to the second embodiment, since the magnetic sensor 51 is single, the construction of the cradle becomes simpler than that of the first embodiment.

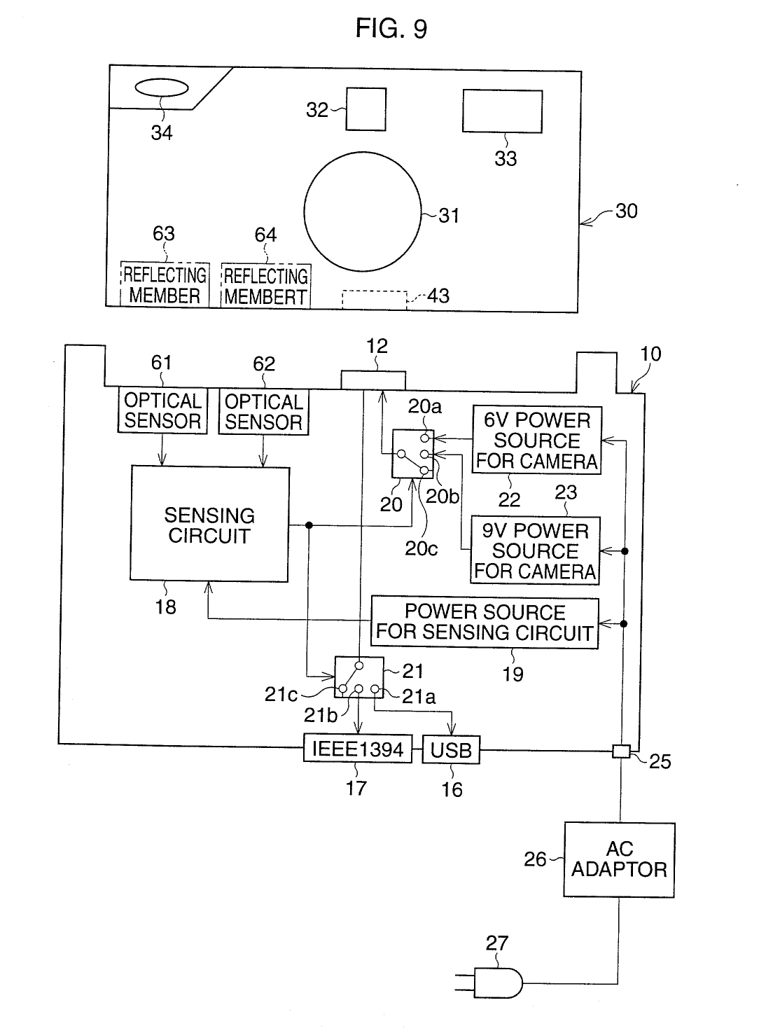

FIG. 9 shows an electric structure of the cradle 10 of a third embodiment. The cradle 10 is provided with first and second optical sensors 61 and 62, and the camera body 30 is provided with a first or second reflecting member 63 or 64. The first and second reflecting members 63 and 64 are located at a position which is changed in accordance with the kind of digital camera. The optical sensors 61 and 62 radiate light, and sense the reflected light generated by the reflecting members 63 and 64. The sensing circuit 18 determines the kind of digital camera by sensing the reflected light. The other constructions and operation are basically the same as those of the first embodiment.

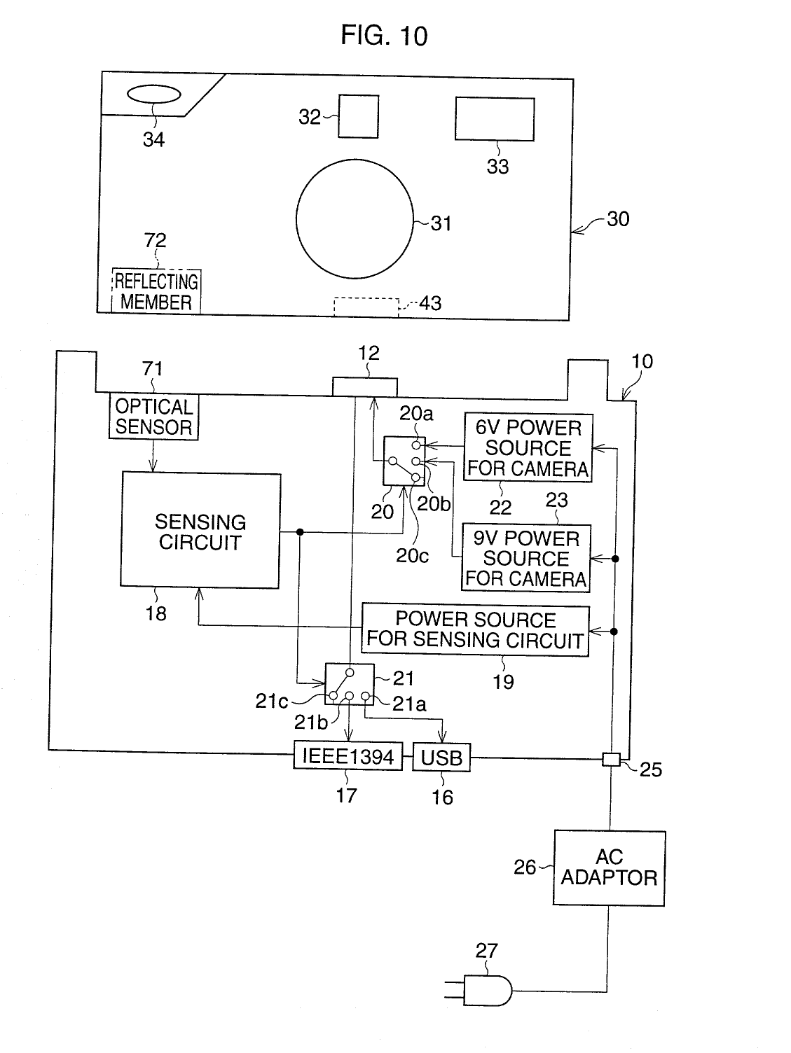

FIG. 10 shows an electric structure of the cradle 10 of a fourth embodiment. The cradle 10 is provided with a single optical sensor 71, and the camera body 30 is provided with a single reflecting member 72, located at a position corresponding to the optical sensor 71. The value of the reflectance of the reflecting member 72 corresponds to the kind of digital camera. Namely, the optical sensor 71 senses the kind of digital camera, based on the amount of reflected light generated by light radiated onto the digital camera.

Thus, according to the fourth embodiment, since the optical sensor 71 is single, the construction of the cradle becomes simpler than that of the third embodiment.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2001-163843 (filed on May 31, 2001) which is expressly incorporated herein, by reference, in its entirety.

1. A cradle for a digital camera, comprising:
a connector to which a plurality of different kinds of digital cameras can be selectively and detachably connected; and
a camera determining processor that has one of a magnetic sensor and an optical sensor, which senses the kind of digital camera connected to said connector.

2. A cradle according to claim 1, wherein said digital camera is provided with a magnet located at a position which changes in accordance with the kind of said digital camera, said camera determining processor determining the kind of said digital camera by sensing said magnet.

3. A cradle according to claim 1, wherein said digital camera is provided with a magnet having a magnetic force the value of which corresponds to the kind of said digital camera, said camera determining processor determining the kind of said digital camera by sensing said magnetic force.

4. A cradle according to claim 1, wherein said digital camera is provided with a reflecting member located at a position which is changed in accordance with the kind of said digital camera, said camera determining processor determining the kind of said digital camera by sensing the reflected light generated by light radiated onto said digital camera.

5. A cradle according to claim 1, wherein said digital camera is provided with a reflecting member having a reflectance the value of which corresponds to the kind of said digital camera, said camera determining processor determining the kind of said digital camera by sensing the amount of reflected light generated by light radiated onto said digital camera.

6. A cradle according to claim 1, further comprising a power source that supplies an electric power of a predetermined voltage to said digital camera in accordance with the result determined by said camera determining processor.

7. A cradle according to claim 6, further comprising a power-source-supply prohibiting processor that prohibits the supply of said electric power by said power source when said camera determining processor senses that said digital camera is not connected to said connector.

8. A cradle according to claim 1, further comprising an interface switch that electrically connects a predetermined communication connector to said digital camera in accordance with the determination result of said camera determining processor.

9. A digital camera system comprising:
a digital camera that is provided with a magnet located at a position which corresponds to the kind of said digital camera; and
a cradle that has a connector to which a plurality of different kinds of digital cameras can be selectively and detachably connected, and a camera determining processor that determines the kind of digital camera connected to said connector by sensing said position of said magnet.

10. A digital camera system comprising:
a digital camera that is provided with a magnet having a magnetic force the value of which corresponds to the kind of said digital camera; and
a cradle that has a connector to which a plurality of different kinds of digital cameras can be selectively and detachably connected, and a camera determining processor that determines the kind of digital camera connected to said connector by sensing said magnetic force.

11. A digital camera system comprising:
a digital camera that is provided with a reflecting member located at a position which corresponds to the kind of said digital camera; and
a cradle that has a connector to which a plurality of different kinds of digital cameras can be selectively and detachably connected, and a camera determining processor that determines the kind of digital camera connected to said connector by sensing the reflected light generated by light radiated onto said reflecting member.

12. A digital camera system comprising:
a digital camera that is provided with a reflecting member having a reflectance value which corresponds to the kind of said digital camera; and
a cradle that has a connector to which a plurality different kinds of digital cameras can be selectively and detachably connected, and a camera determining processor that determines the kind of digital camera connected to said connector by sensing the reflected light generated by light radiated onto said reflecting member.
